(19) United States
(12) Patent Application Publication
(10) Pub. No.: US 2018/0009328 A1
(43) Pub. Date: Jan. 11, 2018

(54) BATTERY HAVING AT LEAST TWO BATTERY CELLS, AND MOTOR VEHICLE

(71) Applicant: AUDI AG, Ingolstadt (DE)

(72) Inventors: Michael HINTERBERGER, Großmehring (DE); Berthold HELLENTHAL, Schwanstetten (DE); Christian ALLMANN, Ingolstadt (DE)

(73) Assignee: AUDI AG, Ingolstadt (DE)

(21) Appl. No.: 15/550,098

(22) PCT Filed: Feb. 16, 2016
(86) PCT No.: PCT/EP2016/053261

§ 371 Date: Aug. 10, 2017

(30) Foreign Application Priority Data
Feb. 18, 2015 (DE) 10 2015 002 154.0

(51) Int. Cl. B60L 11/18; H01M 10/48; H01M 2/10; B60L 3/00; H01M 10/42

(52) U.S. Cl. CPC B60L 11/1853; H01M 2/1077; B60L 11/1861; B60L 3/0046; H01M 10/482; H01M 10/486; B60L 2240/549; B60L 2240/545; H01M 2010/4271; H01M 2220/20

(57) ABSTRACT

A battery with at least two battery cells, which are connected by at least one electric connection element to one another, and a superordinate control device. Each of the battery cells is provided with at least one galvanic element, a battery cell housing for accommodating the galvanic element, at least one sensor device for detecting a physical and/or chemical feature of the battery cell, and a communication device for communicating with the superordinate device. The superordinate device is adapted to control an energy flow in at least one of the battery cells and/or from at least one of the battery cells as a function of the physical and/or chemical features of the battery cell. The invention further also relates to a motor vehicle with such a battery.

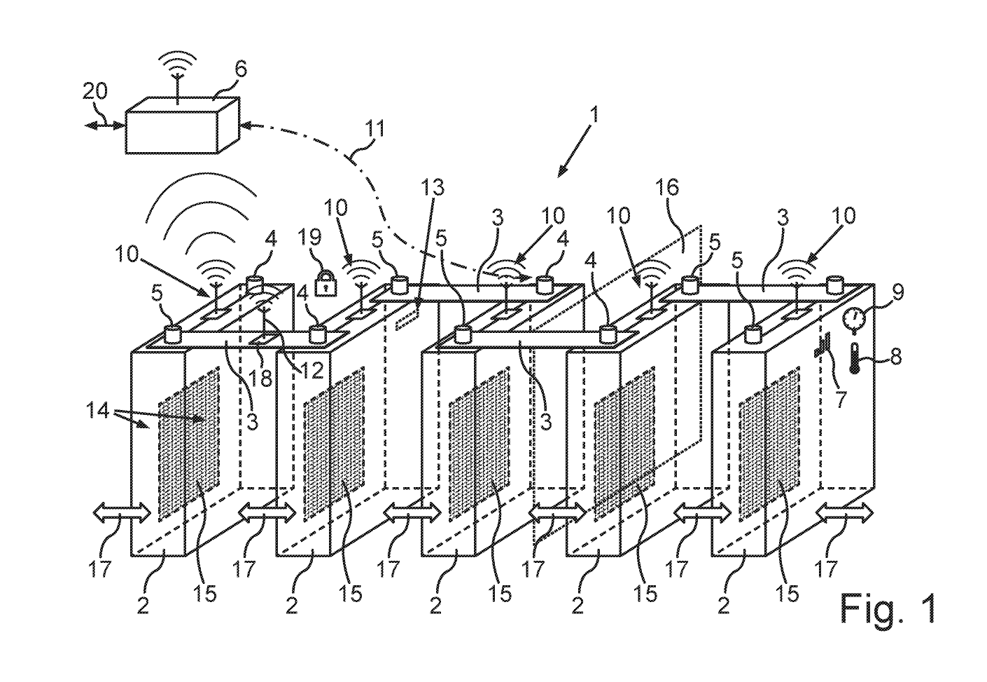

The invention relates to a battery with at least two battery cells which are connected to each other by means of at least one connecting element, and a superordinate control device, wherein each of the battery cells has at least one galvanic element, one battery cell housing for accommodating the galvanic element, at least one sensor device for detecting a physical and/or a chemical property of the battery cell and a communication device for communicating with the superordinate device. The invention also relates to a motor vehicle with a battery.

It is already known from prior art that individual battery cells can be electrically connected to batteries or battery systems and mechanically fixed in a secure manner. These batteries are nowadays used in particular as traction batteries in motor vehicles, for example in electric or hybrid motor vehicles, in order to drive the motor vehicles. However, when the batteries are used in motor vehicles, they must fulfill certain requirements. Since the traction batteries can provide several hundred Volts, special safety measures must be adopted in order to prevent for example hazard to people. In addition, a high availability of the battery must be ensured. This availability is in particular dependent on the extent of damage or aging of the battery. Since the battery cells display fluctuations depending on their manufacture with respect to their capacity as well as with respect to their internal resistance, they are as a rule charged and discharged at a different speed. At the same time, damage to the battery can occur when individual cells are for example deep discharged or overcharged. Damage to the battery or a failure of a battery cell can in this case lead, in particular in particular when the battery cells are connected in series, to a failure of the entire battery.

Measures that can be used in order to monitor individual battery cells or the entire battery are also known from prior art. So for example DE 10 2010 011 740 A1 discloses a battery wherein a status of the sensors of individual battery cells is detected and wirelessly transmitted to a superordinate central unit. In WO 2012/034045 A1 is described a battery monitoring system wherein a measuring devices is mounted on or in a battery cell. WO 2004/047215 A1 also discloses a battery management system wherein the physical properties of the battery are monitored in order the extend the lifespan of the battery.

The object of the present invention is to provide a particularly reliable battery which has a long lifespan and a motor vehicle with such a battery.

This object is achieved according to the invention with a battery and with a motor vehicle having the features according to the independent patent claims. Preferred embodiments of the invention are the subject of the dependent patent claims and of the description and the figures.

The battery according to the invention is provided with at least two battery cells and a superordinate control device. The at least two battery cells are connected to one another by means of at least one electric connection element. Each of the battery cells comprises at least one galvanic element, one battery cell housing for accommodating the galvanic element, at least one sensor device for detecting a physical and/or chemical property of the battery cell and a communication device for communicating with a superordinate control device. In addition, the superordinate device is adapted to control the energy flow in at least one of the battery cells and/or at least one of the battery cells depending on the physical and/or chemical features of the battery cells.

The galvanic element of each battery cells is in particular designed as a secondary cell which can be discharged to supply energy for an electric component and then charged again after discharging. The galvanic element comprises in this case two electrodes and an electrolyte in a known manner. The galvanic element is arranged in the battery cell housing which is manufactured for example from aluminum. The galvanic element can be electrically insulated against the battery cell housing. For this purpose, an insulating material can be arranged for example between the inner side of a wall of the battery cell housing and the galvanic element. The galvanic element is provided with two connections, wherein the respective electrode of the galvanic element is electrically coupled to the respective connection.

For an electric connection of the battery cells, at least one connection of a first battery cell to a connection of a second battery cell is created by means of an electric connection element. The electric connection element can be designed for example as a current rail. In this case, the battery cells can be electrically connected in parallel and/or in series. It can be also provided that individual batteries are connected to battery modules and the battery modules are connected to the battery.

The at least one sensor device of the battery cell serves to detect physical and/or chemical features of the battery cell. The at least one sensor device can be designed for example as a temperature sensor for detecting a temperature in the interior of the battery cell housing and/or as a pressure sensor for detecting a pressure in the interior of the battery cell housing and/or as a chemical detector for detecting a chemical composition of the electrolyte.

The communication device of each of the battery cells can be designed for example as a wireless transmission device, for example as a radio antenna which transmits data to the superordinate control device and/or to the communication device of another battery cell of the battery and/or receives data from the superordinate control device and/or from the communication device of another battery cell. Such data can include for example the features detected by at least one sensor device of the respective battery cell. The data can be transmitted and/or received for example by Bluetooth or by WLAN, but also via ultrasound or with light pulses.

In order to make the wireless data transmission particularly secure, a secure radio connection can be provided as an encrypted, electromagnetically compatible wireless connection for a bidirectional data exchange, for example between the battery cells and the superordinate control device. The data can be transmitted particularly quickly and flexibly by means of a wireless transmission.

However, it can be also provided that the data is transmitted by means of data modulation with a wired line, for example over Ethernet. For this purpose, a data line can be connected for example to the battery cell connections and to the superordinate control device. A reliable and interference-free, encrypted data exchange can be realized in an advantageous manner by means of a transmission over a wired line.

A battery cell that is provided with at least one sensor device and a communication device can be also referred to as an intelligent battery cell or a smart cell.

The at least one sensor device and the communication device of the respective battery cell can in this case be preferably integrated in the semiconductor chip. This highly integrated intelligent semiconductor chip is also referred to as one-chip system or a system on a chip (SoP). With this kind of miniaturization, at least one sensor device and the communication device can be arranged in particularly compact manner in the interior of the battery cell housing of the respective battery. So for example, the semiconductor chip can be arranged in a cavity inside the battery cell housing which can be located for example between an inner side of the wall of the battery cell housing and the galvanic element. At the same time, the semiconductor chip can be thermally coupled to the battery cell housing so that heat that is created during the operation of the semiconductor chip can be removed to the battery cell housing and further to the environment. Outside of the battery cell housing, the semiconductor chip can be arranged in a particularly space-saving manner in particular between the raised or exposed connections of the battery cell housing.

The semiconductor chip can be additionally also provided with a security function. Thus for example, it can be ascertained that a so-called original supplier (OEM—original equipment manufacturer) provided the energy storage device for the battery cell. In addition, individual identification numbers, so-called IDs and other information about the battery cell can be stored electronically. Moreover, the semiconductor chip with the security function is used to detect misuse or a deliberate destruction of the battery cell. In particular, when the semiconductor chip is arranged inside the battery cell housing, the battery would have to be destroyed in order to remove the semiconductor chip. This can be detected by the semiconductor chip. After that, the semiconductor chip can be non-reversibly deactivated.

The superordinate device can be designed as a smart cell controller. In this case, the superordinate control device is designed to exchange data files for example with 12-bit addresses via wireless communication over a distance of for example five meters or more. The superordinate control device can be also provided with a storage device in which the data can be stored. The superordinate control device can also communicate with a battery management system.

The control device can be also designed to measure the energy flow obtained from at least one of the battery cells, and/or the energy flow in at least one of the battery cells, which is to say the charging of at least one of the battery cells, and/or to control the discharging of at least one of the battery cells as a function of the detected physical and/or chemical properties of the batteries. In this case it can be provided that in order to control the energy flow in or out of one of the battery cells, it can be provided that only the physical and/or chemical properties of this particular battery cell or also the physical properties and/or chemical properties of other battery cells of the battery are also taken into account.

The individual control over the energy flow of each of the battery cells, which as a rule will display fluctuations with respect to their capacity depending on their manufacture as well on their internal resistance, makes it in particular possible to prevent a deep discharge or overcharging of the battery and thus causing damage to the entire battery. The lifetime and thus also the availability of the battery can thus be significantly extended.

It is preferred when each of the battery cells is provided with a storage device or with an electronic storage device for storing physical and/or chemical characteristics of the battery cell. In this case, the superordinate device is adapted to control the energy flow as a function of the stored physical and/or chemical properties of the battery cells. This storage device can designed to be integrated together with the at least one sensor device and the communication device in the semiconductor chip. In this case, the storage device can communicate with the at least one sensor device so that the detected data of the at least one sensor device can be transmitted to the storage device. The history of the battery can be thus applied in this manner together with the physical and/or chemical properties of the battery cell over the lifespan of the battery cell. Such properties can include in particular a charging status (SoC—state of charge), a health status (SoH—State of Health), maximum current values or so-called current peaks, or current trajectories of the respective battery cells. The battery can thus be monitored and the energy flow can thus be adjusted in an advantageous manner to the lifespan or to the aging of the respective battery cells.

It can be also provided that the electric connection element is equipped with at least one sensor device for detecting a state variable of the electric connection elements and with a communication device for communicating with the superordinate device, and the superordinate control device is adapted to control the energy flow as a function of the detected state variable Such a state variable may be a current flowing through the electric connection element and/or a temperature and/or an electric potential and/or mechanical expansion and/or mechanical deflection. By means of the sensor device, which is in particular integrated into the electrical connecting element that is designed for example as a current rail, interactions between individual battery cells can thus be also detected in an advantageous manner.

It is preferred when each of the battery cells is provided with at least one switching device, wherein the current flow can be controlled with the electronic switching element by means of a control voltage on the electronic switching element. In other words, this means that an electric resistance can be changed between the electrode and the connection by presetting a corresponding control voltage. In this case, each of the electrodes can be coupled by means of the switching element to the respective connection or only one of both electrodes can be coupled by means of the switching element to the respective connection.

The switching element is preferably designed as an electronic switching element or as a semiconductor, wherein a current flow through the electronic switching element can be controlled at the electronic switching element. In other words, this means that an electric resistance between the electrode and the connection can be changed by presetting a corresponding control voltage. In this case, the superordinate control device is adapted to control the electronic switching element, which is to say for example to preset the corresponding control voltage.

The switching element, which can be designed for example as a power MOSFET (metal oxide semiconductor field effect transistor) or as an IGBT (insulated gate bipolar transistor), can be operated in different regions depending on the control voltage. When the electronic switching element is operated in a blocking region, which is to say when the control voltage is below a predetermined threshold value, the electronic switching element blocks an electric current between the electrode and the respective connection. When the electronic switching element is operated in a linear region or in a triode region, the current flow can be increased by increasing the control voltage. When the electronic control element is operated in a saturation region, a constant, maximum current can flow between the connection and the electrode from a certain predetermined control voltage. The control device is designed to preset the control voltage as a function of the physical and/or chemical properties of the battery cell for the electronic control element.

When for example an increased internal pressure of one of the battery cells or an increased temperature has been detected by the sensor device, which may for example indicate a defect of the battery cell, the superordinate control device can operate this battery cell in the blocking region and thus block a current flowing between the electrodes and the connections of the battery cells in an advantageous manner.

According to an embodiment of the invention, each of the battery cells is provided with an evaluation device which is designed to detect the extent of damage of the respective battery cell as a function of the detected physical and/or chemical properties. The superordinate control device and/or the evaluation device is adapted to control the current flowing between the electrode and the connection of the respective battery cell as a function of the extent of damage of the individual battery cell. The evaluation device can be designed for example as a microcontroller and it can also be integrated in the semiconductor chip. The sensor data inside the battery cell can thus be immediately evaluated and for example transmitted to the superordinate control device only when the evaluated sensor data is outside of the predetermined tolerance range.

The evaluation device is therefore preferably designed to determine the extent of damage or the aging of the respective battery cells as a function of the physical and/or of the chemical properties or of the aging of the respective battery cells. This extent of damage is communicated to the superordinate control device via the communication device, which in particular limits the current flow by controlling the switching element. It can be also provided that the evaluation device itself limits the current flow by controlling the switching device. Gentle operation of the respective battery cell can thus be provided, which enables a longer lifespan.

According to another development of the invention, the sensor devices of each of the battery cells are designed to detect the charging state of the respective battery cell. The superordinate control device is designed to compare the charging states of the battery cells to one another and when a predetermined level of the charging state is exceeded to control the flow of energy in at least one of the battery cells and/or to adjust the charging state in at least one of the battery cells. By detecting the charging state or the capacities and comparing the charging states or the capacities of the individual battery cells to one another, an adjustment of the charging state or so-called balancing can be carried out. The charging states can be determined for example by detecting the voltages of the battery cells. During a balancing of the charging state, at least one energy flow of at least one battery is controlled for as long until all the battery cells display the same charging state—while the usual tolerances are monitored. The advantage of this balancing is that the lifespan of the battery cells and thus of the entire battery is increased.

In an embodiment of the invention, each of the battery cells is provided with a resistive element which is thermally coupled in particular to the respective battery cell housing. The superordinate control device is adapted to electrically connect the resistance element of at least one of the battery cells in order to match the charging states with the electrodes of the galvanic element of the respective battery cell when the predetermined deviation threshold is exceeded. In this case, so called passive or dissipative balancing is carried out so that this battery cell or those battery cells which have a higher charging state in comparison to other battery cells are discharged in a targeted manner via the resistance element. The energy of the respective battery cell is thus converted via the resistance element into heat. In other words, the battery cells are balanced at the same voltage level or at the same charging state.

For this purpose, the superordinate device is designed to connect the resistance element of the battery cell or of the battery cells which display a higher charging state in comparison to the other battery cells to the electrodes of the galvanic element. For this purpose, the resistance element can be electrically connected for example via at least one switching element to the galvanic element, wherein the control device is designed to close the balancing operation performed with the switching element. The resistance element is in this case in particular arranged in the interior of the battery cell housing and thus it can be in an extremely compact manner thermally coupled with the battery cell housing. Since the resistance element converts the energy of the galvanic element in order to discharge energy of the resistance element and convert it into heat, this heat can be discharged to the battery cell housing and further into the area surrounding the battery cell. This makes it possible to prevent that the temperature in the interior of the battery cell housing will be increased too high.

According to another advantageous embodiment of the invention, at least two battery cells are connected in series by means of the electric connection element and at least one side wall of the first of the battery cell housings and at least one side wall of the second battery cell housing are provided with an electrically conductive material which is designed to control the battery cell housing to adjust the charging states when a predetermined deviation limit is exceed for the capacitive energy transferred between the side walls and the battery cell housing.

Here, a so-called active balancing is carried out. In this case, a battery that has a higher charge supplies energy to a battery cell that has a lower charge. This means that the battery cell that is charged with a higher charge is discharged and a battery cell that has lower charge is charged with the energy of the battery cells that had a higher charge. Battery cells that are connected in series are in this case arranged with respect to each other so that two adjacent battery cell housings form a plate capacitor by means of electrically conductive side walls, through which capacitive energy is transmitted by generating an electric alternating field in the plate capacitor. Between the side wall can be located an electric insulation, which forms a dielectric between the electrodes of the plate capacitor. At the same time, the side walls can be coated with an electrically conductive material, for example a film, or they can be produced from an electrically conductive material, for example aluminum.

By means of the connection in series or of the interlinked arrangement of the battery cells and thus also of the plate capacitors, the energy can be dynamically transmitted from a battery cell to an adjacent battery cell. A major advantage with a capacitive transmission, which is based on a displacement current resulting from alternating electric fields, is that almost no losses will occur, for example in the form of heat.

Overall, the invention discloses a battery which is provided with interconnected battery cells or smart cells. Each of the smart cells is equipped with a type of intelligence, for example in the form of sensor devices, evaluation devices and communication devices, by means of which information is available at any time so that the state of the battery cells is also known at any time. With the integration of this intelligence in a semiconductor chip, each of the smart cells is thus designed as a highly integrated, compact energy storage device. It is preferred when the sensor devices, evaluation devices and communication devices are designed as ultra-low power components, whereby a particularly energy-efficient monitoring of the battery cells can be ensured.

A motor vehicle according to the invention comprises at least one battery according to the invention. The motor vehicle can be for example designed as a personal automobile, in particular as an electric or hybrid motor vehicle. However, the motor vehicle can be also designed as an electrically operated motorcycle or bicycle.

Moreover, it is also possible to provide the battery in a stationary energy storage system. In this case it can be for example provided that the battery that is provided in a motor vehicle is reused as a so-called second life battery in an energy storage system.

The preferred embodiments described with respect to the battery according to the invention apply accordingly also the vehicle according to the invention.

The invention will now be described in the following based on a preferred embodiment, as well as with reference to the attached FIGURE.

The single FIGURE shows a schematic representation of a battery with battery cells.

The embodiment described in the following is a preferred embodiment of the invention. However, the components of the embodiment that are described in the embodiment represent individual features of the invention which are independent of one another, wherein each of them also further develops the invention independently of each other and thus also individually, or in a combination that is different from the shown combination and that should be seen as a component of the invention. In addition, the described embodiment can be complemented also by other features of the invention that have been already described.

The FIGURE shows a battery 1, of which only five battery cells 2 are shown. Only the battery cell housings of the battery cells 2 are visible here. Inside the battery cell housing is arranged a respective galvanic element. The battery cells 2 are here connected via a respective electric connection element 3 designed in the form of a current rail to the battery 1. Here, the battery cells 2 are connected via the electric connection element 3 in series, wherein a respective connection 4 of a battery cell 2 is electrically connected to a negative connection 5 of an adjacent battery cell 2. In addition, the battery 1 is provided with a superordinate control device 6.

Each of the battery cells 1 is provided with at least one of the sensor devices 7, 8, 9 which are used to detect physical and/or chemical properties of the battery cells 2. In this case, the sensor device 7 is designed as a charging state sensor detecting a charging state of the respective battery cell 2, the sensor device 8 is designed as a temperature sensor detecting a temperature in the interior of the battery cell housing of the respective battery cell 2, and the sensor device 9 is designed as a pressure sensor detecting a pressure in the interior of the battery cell housing of the respective battery cell 2. The sensor devices 7, 8, 9 are here arranged within the battery cell housing of each battery cell 2.

Moreover, each of the battery cells 2 is provided with a communication device 10 in the form of a radio antenna. The battery cells 2 can communicate via the respective communication device 10 with the superordinate control device 6. The communication takes place as wireless communication, for example via WLAN or Bluetooth or the like. However, it can be also provided that each of the battery cells 2 communicates via a line 11 with the superordinate control device 6. For this purpose, the line 11 is connected for example with one of the connections 4, 5 to the battery cells 2. The line 11 can be a so-called Ethernet cable. The data can be thus transmitted in this manner between the superordinate control device 6 and the respective battery cell 2. The line 11 can be also a so called power line, wherein the data is transmitted through the power grid.

Each of the battery cells 2 is in this case also provided with a security function 19, by means of which it can be for example ensured that the energy storage device has been supplied by a so-called original manufacturer (OEM—original equipment manufacturer). Individual identification numbers, so-called IDs and other information can be electronically stored therein for each battery cell 2.

It can be also provided that each of the electric connection elements 3 is equipped with a sensor device 18 and with a communication device 12 for communicating with the superordinate control device 6. The data of the sensor device 18 of the electric connection element 3 can be transmitted by means of this communication device 12 to the superordinate control device 6. Such data can for example indicate a current that flows via the electric connection element 3 between the connections 4, 5 of two battery cells 2, or a temperature, or a mechanic deflection of the electric connection element 3.

The control device 6 is in this case designed to receive the transmitted data, which is to say the data of the sensor devices 7, 8, 9 and/or the data relating to the electric connection elements 3 so as to control as a function of this data the energy flow from at least one of the battery cells and/or in one of the battery cells 2. It can be also provided that the superordinate control device communicates with a battery management system, not shown here, for example via a bus connection 20.

It can be further also provided that each of the battery cells 2 is equipped with an evaluation device which itself is designed to carry out the evaluation of the data of the sensor devices 7, 8, 9. It can be furthermore also provided that calculations are carried out by the superordinate device 6 and only the results are transmitted to the evaluation device of the respective battery cell 2.

For example an impedance analysis or an impedance microscopy can be carried out by means of the evaluation device for each of the battery cells 2 and a statement can thus be obtained for example about the internal resistance of each of the battery cells 2. So for example, the energy flow can be adapted to the inner resistance of the respective battery cell 2 in order to ensure in this manner an equal load on all of the battery cells 2 of the battery 1. It is also possible to provide information for a charging column, which is to say a device for providing charging energy, in an active manner about the actual state, for example about the state of health (SoH) of each of the battery cells 2. For example, the charging can be dynamically adapted to the state of the respective battery cell 2 and for example actively switched off in case of a critical state of the battery cell 2.

In order to control the flow of energy, each of the battery cells 2 may be provided with a switching device 13. The switching device 13 can have an electronic switching element and/or a relay. A current flow is controlled by means of the switching device, in particular between the galvanic element in the battery cell housing and the connections 4, 5 of the same battery cell 2, wherein a control signal is provided for instance by the superordinate control device 6, for instance a control voltage. In particular, a current flow can be limited or interrupted by means of the switching device 13 between the galvanic element and the connections 4, 5. The switching device 13 can therefore fulfill the function of a fuse that is per se known.

The superordinate control device 6 is preferably designed to control a current flow as the energy flow between the galvanic element and the connections 4, 5 of at least one of the battery cells 2 by means of a switching device 13. The current flow can then be interrupted or blocked, for example by the switching device 13 that is controlled by the superordinate control device 6, when a current load of this battery cell 2 appears to be dangerous. This can occur, for example, when it was detected by the sensor device 9 that the pressure in the battery cell housing has exceeded a threshold value predetermined for a pressure and this increased pressure value was communicated to the superordinate control device 6, for example via the communication device 10 of the battery cell 2. After that, the superordinate control device 6 can control the switching device 13 in order to block the current flow. The current flow of a battery cell 2 can be also limited if the battery cell 2 for example displays a state of health (SoH) which indicates aging or damage of the battery cell 2.

The switching device 13 can be switched on by the evaluation device of each of the respective battery cells 2, in particular depending on the data sensor devices 7, 8, 9 of the respective battery cells 2.

In the case of the battery 1, several battery cells 2 can be also connected to one battery module and multiple battery modules can be connected together. According to an embodiment of the switching device 13 which is realized as a power semiconductor element, with this embodiment it can be in addition ensured that the battery 1 can compensate for a resulting total resistance, which is dependent on the respective length and on the linking of the current rail to the respective connection 4, 5, as well as on the transition between the battery modules. In other words, this means that an internal resistance of each of the battery cells 2 can be dynamically adjusted by means of the switching device 13. The battery cells are thus subjected to an equal load as a result of a total resistance compensation and they will thus also age equally in the long term.

An energy flow between the battery cells 2 can be also controlled to create an equal charging state of the battery cells 2. When for example a first charging state of one of the battery cells 2 was detected by one of the sensor devices 7 and another charging state of another of the battery cells 2 was detected by the sensor device 7 which is greater compared to the first charging state, the superordinate control device 6 can determine a deviation between the first and the second charging state. When this deviation exceeds a predetermined threshold value of the deviation, the superordinate control device 6 can carry out a balancing or a compensation of the charging state.

For this purpose, the battery cells can be discharged with the second charging state, for example via a resistance element, not shown here. The superordinate device 6 can for this purpose connect the resistance element, for example by means of a switching element, so that the electrodes of the galvanic element of the battery cell 2 are connected with the second charging state until the second charging state is matched to the first charging state. This is referred to as passive or dissipative balancing.

The superordinate control device 6 can also carry out active balancing, so that it controls the energy flow from the battery cell 2 occurring with the second charging state with the first charging state. Here, the electric energy is capacitively transmitted from the battery cell 2 with the second charging state to the battery cell 2 with the first charging state. For this purpose, the side walls 14 of the battery cell housing of the battery cells 2 are provided with an electrically conductive material 15. It can be also provided that the battery cell housing is already manufactured from the electrically conductive material 15, for example aluminum. In this manner, the electrodes of the plate capacitor are formed by means of two side walls 14 which are facing each other. In this case, the side walls 13 form the electrodes of the plate capacitor and a an insulating material 16 arranged between the side walls 14 forms a dielectric of the plate capacitor. A capacitive energy transmission 17 can thus be obtained by means of this plate capacitor between two adjacent battery cells 2. In this case, the capacitive energy of the battery cells can also occur via a plurality of the battery cells 2. With the energy transfer from a battery cell 2 to an adjacent battery cells 2, it is therefore not required to first store the energy to be distributed in the respective battery cell 2 and then to remove it again and thus possibly to operate the battery cell 2 outside of the limits set by the chemistry of the battery cell. As a result of the interlinked plate capacitor arrangement, there is the option to transmit the energy amount to be distributed directly to the next battery cell 2 in a dynamic and targeted manner, which is to say without storing it in a battery cell 2.

1-10. (canceled)

11. A battery, comprising:
at least two battery cells, which are connected to each other by means of an electric connection element, and with a superordinate control device, wherein each of the battery cells is provided with at least one galvanic element, a battery cell housing for accommodating the galvanic element, at least one sensor device for detecting at least one physical and chemical feature of the battery cell and a communication device for communicating with the superordinate control device, wherein the superordinate control device is adapted to control as a function of the physical and chemical features of the battery cells an energy flow in at least one of the battery cells and from at least of the battery cells.

12. The battery according to claim 11, wherein each of the battery cells is provided with a storage device for storing the physical and chemical features of the battery cell and the superordinate cell is adapted to control the energy flow as a function of the stored physical and chemical features of the battery cells.

13. The battery according to claim 11, wherein the electric connection element is provided with at least one sensor device for detecting state variables of the electric connection element and a communication device for communicating with the superordinate control device, and the superordinate control device is adapted to control the energy flow as a function of the detected state variable.

14. The battery according to claim 11, wherein each of the battery cells is provided with at least one switching device by means of which an electrode of the galvanic element and a connection of the respective battery cell are electrically coupled and by means of which a current flow between the galvanic element and the connection of the respective battery cell can be controlled, and the superordinate control device is designed to control as energy flow the current flow between the electrode and the connection of at least one of the battery cells.

15. The battery according to claim 14, wherein at least one sensor device of each of the battery cells is provided with a temperature sensor for detecting a temperature and with a pressure sensor for detecting a pressure of the respective battery cell and the superordinate control device is adapted to control the current flow between the electrode and the connection of the respective battery cells as a function of the temperature and of the pressure of the respective battery cell.

16. The battery according to claim 14, wherein each of the battery cells is respectively provided with an evaluation device, which is adapted as a function of the detected physical and chemical features to determine the extent of the damage of the respective battery cell, wherein the superordinate control device and the evaluation device is adapted to control the current flow between the electrode and the connection of the respective battery cell as a function of the extent of damage to the respective battery cell.

17. The battery according to claim 15, wherein the at least one sensor device of each of the battery cells is designed to detect a charging state of the respective battery cell, wherein the superordinate control device is adapted to compare the charging states of the battery cells to one another and when a predetermined deviation limit for the charging state is exceeded, to control the charging states in order to match them.

18. The battery according to claim 17, wherein each of the battery cells is provided with a resistance element which is in particular thermally coupled to the battery cell housing, and the superordinate control device is adapted to electrically connect at least one battery cell for matching the charging states with the electrodes of the galvanic element of the respective battery cell when the predetermined deviation limit is exceeded.

19. The battery according to claim 17, wherein the at least two battery cells are connected in series by means of the electric connection element and at least one side wall of a first battery cell housing and at least one side wall of a second battery cell housing is provided with an electrically conductive material, and the superordinate control device is designed to control a capacitive energy transmission between the side walls of the battery cell housing when the predetermined deviation limit is exceeded so as to match the charging states.
